(19) United States
(12) Patent Application Publication
(10) Pub. No.: US 2026/0321291 A1
(43) Pub. Date: Oct. 15, 2026

(54) METHOD FOR UTILIZING CLIPPING DATA ON BASIS OF OBJECT RECOGNITION, AND ELECTRONIC DEVICE THEREOF

(71) Applicant: Samsung Electronics Co., Ltd., Suwon-si (KR)

(72) Inventors: Jeeeun HONG, Suwon-si (KR); Jiyoung KANG, Suwon-si (KR); Eunah LEE, Suwon-si (KR); Yuran KIM, Suwon-si (KR); Yeunwook LIM, Suwon-si (KR)

(21) Appl. No.: 19/462,425

(22) Filed: Jan. 28, 2026

Related U.S. Application Data
(63) Continuation of application No. PCT/KR2024/008001, filed on Jun. 11, 2024.

(30) Foreign Application Priority Data
Jul. 31, 2023 (KR) 10-2023-0099490
Nov. 20, 2023 (KR) 10-2023-0160134

(51) Int. Cl. G11B 27/031; G06V 10/764

(52) U.S. Cl. CPC G11B 27/031; G06V 10/764

(57) ABSTRACT

An electronic device is provided. The electronic device includes a display, memory, comprising one or more storage media, storing instructions, and one or more processors communicatively coupled to the display and the memory, wherein the instructions, when executed by the one or more processors individually or collectively, cause the electronic device to recognize a plurality of objects from an image or video displayed on the display, based on a user input, separate one object or multiple objects from the plurality of objects that are recognized, generate clipping data from the one object or multiple objects separated from the plurality of objects, display the clipping data on the display, and store, in the memory, the clipping data together with metadata of the image or video including the plurality of objects.

### CROSS-REFERENCE TO RELATED APPLICATIONS

This application is a continuation application, claiming priority under 35 U.S.C. § 365(c), of an International application No. PCT/KR2024/008001, filed on Jun. 11, 2024, which is based on and claims the benefit of a Korean patent application number 10-2023-0099490, filed on Jul 31, 2023, in the Korean Intellectual Property Office, and of a Korean patent application number 10-2023-0160134, filed on Nov. 20, 2023, in the Korean Intellectual Property Office, the disclosure of each of which is incorporated by reference herein in its entirety.

### BACKGROUND

### 1. Field

The disclosure relates to a method of utilizing clipping data based on object recognition and an electronic device thereof.

### 2. Description of Related Art

With the development of digital technologies, various types of electronic devices are widely utilized, such as, mobile communication terminals, personal digital assistants (PDA), electronic organizers, smartphones, tablet personal computers (PC), wearable devices, and the like. Hardware parts and/or software parts of the electronic device have been continuously improved in order to support and increase the functions of the electronic device.

Meanwhile, users have been sharing their daily lives and communicating with a large number of other users who have similar interests or tastes via a social network service (SNS). The user may want to post an image that represents a unique individuality different from other users on the SNS. The electronic device provides various methods of extracting a region desired by a user from an image or video and generates a new image or video.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for recognizing an object from an image (or video), separating, when a plurality of objects is recognized, the plurality of recognized objects into one or more objects, and generating and utilizing clipping data (e.g., sticker) by using the separated objects.

Additional aspects will be set forth in part in the description which follows and, in part, will be apparent from the description, or may be learned by practice of the presented embodiments.

In accordance with an aspect of the disclosure, an electronic device is provided. The electronic device includes a display, memory, including one or more storage media, storing instructions, and one or more processors communicatively coupled to the display and the memory, wherein the instructions, when executed by the one or more processors individually or collectively, cause the electronic device to recognize a plurality of objects from an image or video displayed on the display, based on a user input, separate one object or multiple objects from the plurality of objects that are recognized, generate clipping data from the one object or multiple objects separated from the plurality of objects, display the clipping data on the display, and store, in the memory, the clipping data together with metadata of the image or video including the plurality of objects.

In accordance with another aspect of the disclosure, A method performed by an electronic device is provided. The method includes recognizing, by the electronic device, a plurality of objects from an image or video displayed on a display of the electronic device, based on a user input, separating, by the electronic device, one object or multiple objects from the plurality of objects that are recognized, generating, by the electronic device, clipping data from the one object or multiple objects separated from the plurality of objects, displaying, by the electronic device, the clipping data on the display, and storing, by the electronic device in memory of the electronic device, the clipping data together with metadata of the image or video including the plurality of objects.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include recognizing, by the electronic device, a plurality of objects from an image or video displayed on a display of the electronic device, based on a user input, separating, by the electronic device, one object or multiple objects from the plurality of objects that are recognized, generating, by the electronic device, clipping data from the one object or multiple objects separated from the plurality of objects, displaying, by the electronic device, the clipping data on the display, and storing, by the electronic device in memory of the electronic device, the clipping data together with metadata of the image or video including the plurality of objects.

According to an embodiment, a plurality of objects can be recognized at once from an image or video to generate clipping data.

According to an embodiment, when a plurality of objects is recognized, clipping data can be generated or edited from one or more objects.

According to an embodiment, usability of clipping data can be increased by categorizing and storing clipping data, based on metadata of an image or video.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a diagram illustrating an example of recognizing an object and generating clipping data in an electronic device according to an embodiment of the disclosure;

FIG. 3 is a flowchart illustrating an operation method of an electronic device according to an embodiment of the disclosure;

FIG. 4A is a diagram illustrating an example of recognizing a plurality of objects in an electronic device according to an embodiment of the disclosure;

FIG. 4B illustrates an example of separating a single object into a plurality of objects in an electronic device according to an embodiment of the disclosure;

FIG. 5 is a flowchart illustrating a clipping data generation method of an electronic device according to an embodiment of the disclosure;

FIG. 6A is a diagram illustrating an example of generating clipping data in an electronic device according to an embodiment of the disclosure;

FIG. 6B is a diagram illustrating an example of correcting an object and generating clipping data in an electronic device according to an embodiment of the disclosure;

FIG. 7 is a flowchart illustrating a clipping data utilization method of an electronic device according to an embodiment of the disclosure;

FIGS. 8A and 8B are diagrams illustrating an example of inserting clipping data in an electronic device according to various embodiments of the disclosure;

FIG. 9 is a flowchart illustrating a clipping data merging method of an electronic device according to an embodiment of the disclosure;

FIG. 10 is a flowchart illustrating an object editing method of an electronic device according to an embodiment of the disclosure;

FIGS. 11A, 11B, and 11C, are diagrams illustrating an example of editing an object in an electronic device according to various embodiments of the disclosure;

FIG. 12 is a diagram illustrating an example of generating, editing, and utilizing clipping data from a selected image in an electronic device according to an embodiment of the disclosure;

FIG. 13 is a diagram illustrating an example of generating, editing, and utilizing clipping data from a selected image in an electronic device according to an embodiment of the disclosure;

FIGS. 14A and 14B are diagrams illustrating an example of utilizing clipping data in an electronic device according to various embodiments of the disclosure; and

FIGS. 15A and 15B are diagrams illustrating an example of utilizing clipping data in an electronic device according to various embodiments of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi^{TM}) chip, a Bluetooth^{TM} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

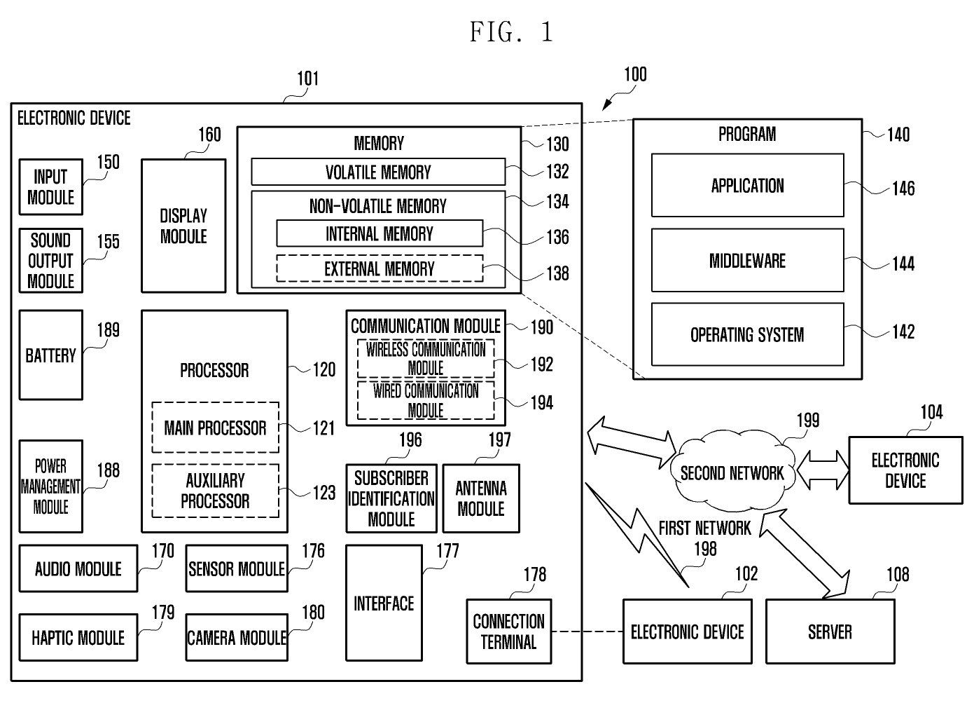

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connection terminal 178, a haptic module 179, a camera module 180, a power management module 188, a battery 189, a communication module 190, a subscriber identification module (SIM) 196, or an antenna module 197. In some embodiments, at least one of the components (e.g., the connection terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., the electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

The connection terminal 178 may include a connector via which the electronic device 101 may be physically connected with the external electronic device (e.g., the electronic device 102). According to an embodiment, the connection terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth^{TM}, wireless-fidelity (Wi-Fi^{TM}) direct, or infrared data association (IrDA)) or the second network 199 (e.g., a long-range communication network, such as a legacy cellular network, a 5th generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4th generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164dB or less) for implementing mMTC, or U-plane latency (e.g., 0.5ms or less for each of downlink (DL) and uplink (UL), or a round trip of 1ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to certain embodiments, the antenna module 197 may form a mmWave antenna module. According to an embodiment, the mmWave antenna module may include a printed circuit board, an RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices (e.g., the electronic devices 102 and 104 and the server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments disclosed herein may be one of various types of electronic devices. The electronic devices may include, for example, a portable communication device (e.g., a smart phone), a computer device, a portable multimedia device, a portable medical device, a camera, a wearable device, or a home appliance. The electronic device according to embodiments of the disclosure is not limited to those described above.

It should be appreciated that various embodiments of the disclosure and the terms used therein are not intended to limit the technological features set forth herein to particular embodiments and include various changes, equivalents, or alternatives for a corresponding embodiment. With regard to the description of the drawings, similar reference numerals may be used to designate similar or relevant elements. As used herein, each of such phrases as "A or B," "at least one of A and B," “at least one of A or B,” "A, B, or C," "at least one of A, B, and C," and “at least one of A, B, or C,” may include all possible combinations of the items enumerated together in a corresponding one of the phrases. As used herein, such terms as "a first", "a second", “the first”, and "the second" may be used to simply distinguish a corresponding element from another, and does not limit the elements in other aspect (e.g., importance or order). It is to be understood that if an element (e.g., a first element) is referred to, with or without the term “operatively” or “communicatively”, as “coupled with/to” or "connected with/to" another element (e.g., a second element), it means that the element may be coupled/connected with/to the other element directly (e.g., wiredly), wirelessly, or via a third element.

As used herein, the term "module" may include a unit implemented in hardware, software, or firmware, and may be interchangeably used with other terms, for example, "logic," "logic block," "component," or "circuit". The “module” may be a minimum unit of a single integrated component adapted to perform one or more functions, or a part thereof. For example, according to an embodiment, the “module” may be implemented in the form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store^{TM}), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities mat be separately disposed in any other element. According to various embodiments, one or more of the above-described elements may be omitted, or one or more other elements may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

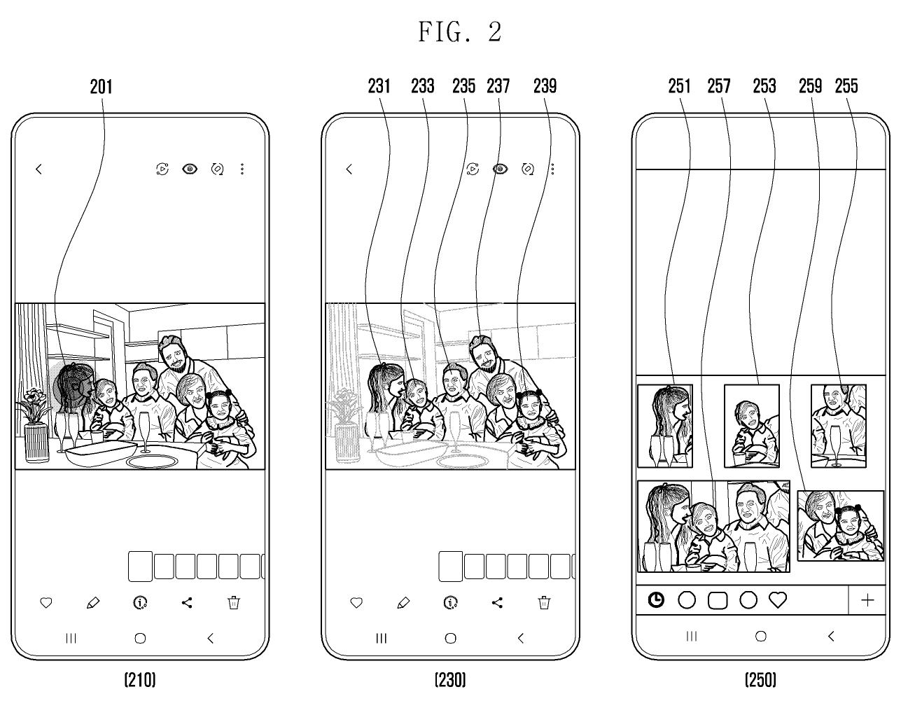

FIG. 2 is a diagram illustrating an example of recognizing an object and generating clipping data in an electronic device according to an embodiment of the disclosure.

Referring to FIG. 2, a processor (e.g., processor 120 of FIG. 1) of an electronic device (e.g., electronic device 101) according to an embodiment may display a first user interface 210 including an image or video on a display (e.g., display module 160 of FIG. 1). The image or video may be stored in memory (e.g., memory 130 in FIG. 1) of the electronic device 101, stored in a cloud server (e.g., server 108 in FIG. 1), downloaded from the server 108, or disclosed in the server 108. The first user interface 210 may be an execution screen of a gallery application, an execution screen of a search application displaying an image or video on a web page, or an execution screen of a social network service (SNS)-related application. Since the image or video is stored, captured, downloaded, or displayed, the first user interface 210 may be one of execution screens of other applications in addition to the aforementioned ones. In the following description, although a thing that is displayed in the first user interface 210 is described as an image, the disclosure is not limited by this description. When an image or video is displayed on the display module 160, the processor 120 may recognize an object from the displayed image or video.

The object may include all things capable of being used for generating clipping data, such as a person, a thing (e.g., car, streetlight, or desk), an animal, or a background. For example, the background may be a concept that generically refers to at least some or all of things excluding a person, a thing, or an animal, and may be the sky, the sea, or a mountain. The processor 120 may detect (or receive) a user input 201 on the first user interface 210. For example, the user input 201 may be selecting a point (or region) on the image displayed on the first user interface 210, which may be, for example, an input of selecting an object. The processor 120 may recognize an object from the first user interface 210 based on the user input 201. The processor 120 may recognize an object and may represent the same differently for each recognized object. For example, the processor 120 may display a boundary of the recognized object each object.

The processor 120 may provide (or display) a second user interface 230 based on the user input 201. When a plurality of objects is recognized, the processor 120 may separate one or multiple objects from the plurality of objects. Referring to the second user interface 230, the processor 120 may separate the plurality of objects into a first object 231, a second object 233, a third object 235, a fourth object 237, and a fifth object 239. Each of the first object 231 to the fourth object 237 may be an object including one person. The fifth object 239 may be an object including two persons.

According to an embodiment, the processor 120 may analyze the plurality of recognized objects, and separate one or multiple objects from the plurality of objects, based on the analyzed result. For example, the processor 120 may analyze metadata of the image including the plurality of recognized objects, image or video stored in the memory 130, or image or video stored (or registered) in the server 108 in association with a user of the electronic device 101. Based on the analysis result, the processor 120 may identify that the first object 231 is the user of the electronic device 101, the second object 233 is a child of the user, and the first object 231 to the third object 235 are the user’s family members. Since the technology for recognizing and analyzing objects included in an image is conventional art, a detailed description thereof may be omitted.

The processor 120 may provide (or display) a third user interface 250 in which clipping data is generated using the separated objects. According to an embodiment, the processor 120 may automatically enter the third user interface 250, or may switch to the third user interface 250 based on a user input (e.g., menu selection, gesture, etc.). The clipping data is image or video data including each recognized object, and may be, for example, a sticker, an emoji, an emoticon, or the like. The clipping data may include an image (e.g., still image) or a video (e.g., moving image). The processor 120 may generate moving image by using the clipping data based on the front/back frames of a video including the recognized object. The third user interface 250 may include first clipping data 251 to fifth clipping data 259 generated from the image or video displayed on the display module 160. The clipping data illustrated in the drawing may have a rectangular shape including an object, or may have a shape formed along the boundary of an object.

For example, the first clipping data 251 may correspond to the first object 231, second clipping data 253 may correspond to the second object 233, and third clipping data 255 may correspond to the third object 235. Fourth clipping data 257 may correspond to the first object 231 to the third object 235, and the fifth clipping data 259 may correspond to the fifth object 239. The clipping data may correspond (or be matched) to one object in a one-to-one manner, or may include a plurality of objects. The processor 120 may generate the fourth clipping data 257 by grouping adjacent objects (e.g., first object 231 to third object 235). Alternatively, the processor 120 may generate fourth clipping data 257 based on metadata (e.g., family) of the objects via the object analysis.

An electronic device according to an embodiment of the disclosure may include the display module 160, the memory 130, and the processor 120, and instructions stored in the memory may, when executed by the processor, cause the electronic device to recognize a plurality of objects from an image or video displayed on the display, to separate one or multiple objects from the plurality of recognized objects, based on a user input, to generate clipping data from the separated objects, to display the generated clipping data on the display, and to store, in the memory, the displayed clipping data together with metadata of the image or video including the plurality of objects.

The instructions may, when executed by the processor, cause the electronic device to detect a second user input to select a first object after recognizing the plurality of objects, to edit the selected first object based on a third user input, and to store the edited first object and the plurality of objects as one object.

The instructions may, when executed by the processor, cause the electronic device to edit, based on the third user input, at least one of a size, a location, an angle, or a shape of the first object.

The instructions may, when executed by the processor, cause the electronic device to merge the edited first object into a designated region of the image or video.

The instructions may, when executed by the processor, cause the electronic device to adjust at least one of a size, a location, an angle, or a shape of the edited first object when merging the edited first object.

The instructions may, when executed by the processor, cause the electronic device to rearrange the edited first object in the image or video based on the edited first object, and store, in the memory, the rearranged object together with the metadata of the image or video.

The instructions may, when executed by the processor, cause the electronic device to recognize at least one of a person, a thing, an animal, or a background from the displayed image or video as one object, and to divide, when one object is recognized, the recognized object into a plurality of regions of interest and identify the recognized object as a plurality of objects.

The instructions may, when executed by the processor, cause the electronic device to group, based on the metadata, clipping data stored in the memory.

The instructions may, when executed by the processor, cause the electronic device to detect a first predetermined input in a state in which first clipping data is inserted, to identify second clipping data in a first group which the first clipping data belongs to, in response to the first predetermined input; and to change the first clipping data to the second clipping data.

The instructions may, when executed by the processor, cause the electronic device to detect a second predetermined input in a state in which first clipping data is inserted, to identify third clipping data in a second group which the first clipping data belongs to, in response to the second predetermined input, and to change the first clipping data to the third clipping data.

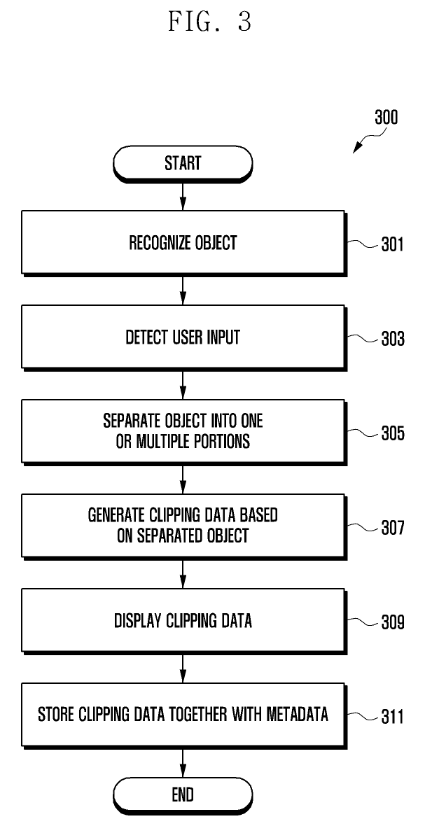

FIG. 3 is a flowchart illustrating an operation method of an electronic device according to an embodiment of the disclosure.

Referring to FIG. 3, flowchart 300 illustrates that, in operation 301, a processor (e.g., processor 120 of FIG. 1) of an electronic device (e.g., electronic device 101) according to an embodiment may recognize an object. The processor 120 may recognize an object, and a plurality of objects may be recognized. The processor 120 may display an image or video on a display (e.g., display module 160 of FIG. 1). The image or video may be stored in memory (e.g., memory 130 in FIG. 1) of the electronic device 101, stored in a cloud server (e.g., server 108 in FIG. 1), downloaded from the server 108, or disclosed in the server 108. The processor 120 may recognize an object from the displayed image or the displayed video. The object may include at least one of a person, a thing, an animal, or a background.

According to an embodiment, although it is illustrated that operation 301 is performed first in the drawing, operation 301 may be performed after operation 303 or may be performed in parallel (or simultaneously) with operation 305. The processor 120 may recognize an object, and when a plurality of objects is recognized, the processor 120 may display the objects differently for each object. For example, the processor 120 may display a boundary of the recognized object for each object.

In operation 303, the processor 120 may detect a user input. The user input may be to select (e.g., to touch) any point (or region) on the displayed image (or video). Alternatively, the user input may be an input for selecting at least one object among the objects included in the displayed image. Alternatively, the user input may be requesting editing (e.g., selecting an editing item) via a menu item supported by the electronic device 101, or requesting clipping data generation (e.g., selecting data generation). Alternatively, upon recognizing the object, the processor 120 may generate the clipping data, automatically (e.g., without a user input). In this instance, operation 303 may be omitted.

In operation 305, the processor 120 may separate the object into one or multiple portions. For example, the displayed image (or video) may include one person, or may include two or more persons. The processor 120 may determine whether the object included in the displayed image is one (e.g., single) object or a plurality of objects. When a single object is included in the displayed image, the processor 120 may divide the single object into a plurality of regions of interest. Even when a plurality of objects is included in the displayed image, the processor 120 may divide the plurality of objects into a plurality of regions of interest. For example, when one person (e.g., upper body) is included in the displayed image, the processor 120 may divide the one person into two regions of interest, a face or a whole (e.g., entire upper body), or divide the one person into three regions of interest, a face, a face to a shoulder, or a whole (e.g., entire upper body). Alternatively, when an animal (e.g., full body) is included in the displayed image, the processor 120 may divide the animal into two regions of interest, a face or a full body, or may divide the animal into three regions of interest, a face, a tail, or a full body.

When a plurality of objects is included in the displayed image, the processor 120 may separate one or multiple objects from the plurality of objects. According to an embodiment, the processor 120 may analyze the plurality of recognized objects, and separate one or multiple objects from the plurality of objects, based on the analyzed result. For example, the processor 120 may analyze metadata of the image including the plurality of recognized objects, image or video stored in the memory 130, or image or video stored (or registered) in the server 108 in association with a user of the electronic device 101. Since the technology for recognizing and analyzing objects included in an image is conventional art, a detailed description thereof may be omitted. For example, the processor 120 may separate one object or separate one object including two or more objects from the plurality of objects.

In operation 307, the processor 120 may generate clipping data based on the separated object. The clipping data may be a sticker, emoji, emoticon, or the like. The clipping data may include an image (e.g., still image) or video (e.g., moving image). The processor 120 may generate moving image by using the clipping data based on the front/back frames of a video including the recognized object. For example, the processor 120 may generate one piece of clipping data from one object, or generate one piece of clipping data from a plurality of objects. Alternatively, the processor 120 may generate clipping data from a plurality of regions of interest. Upon recognizing the object, the processor 120 may generate the clipping data, automatically (e.g., without a user input).

In operation 309, the processor 120 may display the generated clipping data. The processor 120 may display only the generated clipping data on the display module 160. The processor 120 may display the generated clipping data together with the image or the video on the display module 160.

In operation 311, the processor 120 may store the clipping data together with metadata. The metadata may refer to metadata of an image (or video) including the plurality of recognized objects. The metadata may include at least one of a date, time, and location at which the image is generated (or captured, downloaded, or edited). Alternatively, the processor 120 may utilize data (e.g., family, companion animal, and travel) obtained via object analysis or image analysis as the metadata. According to an embodiment, the processor 120 may classify clipping data based on metadata, and store the same in the memory 130. For example, the processor 120 may categorize first clipping data as the user of the electronic device 101, the user’s upper body photograph, or the user’s first overseas trip, and store the same in the memory 130. Alternatively, the processor 120 may categorize second clipping data as an animal, a companion animal of the user of the electronic device 101, or a full picture and store the same in the memory 130.

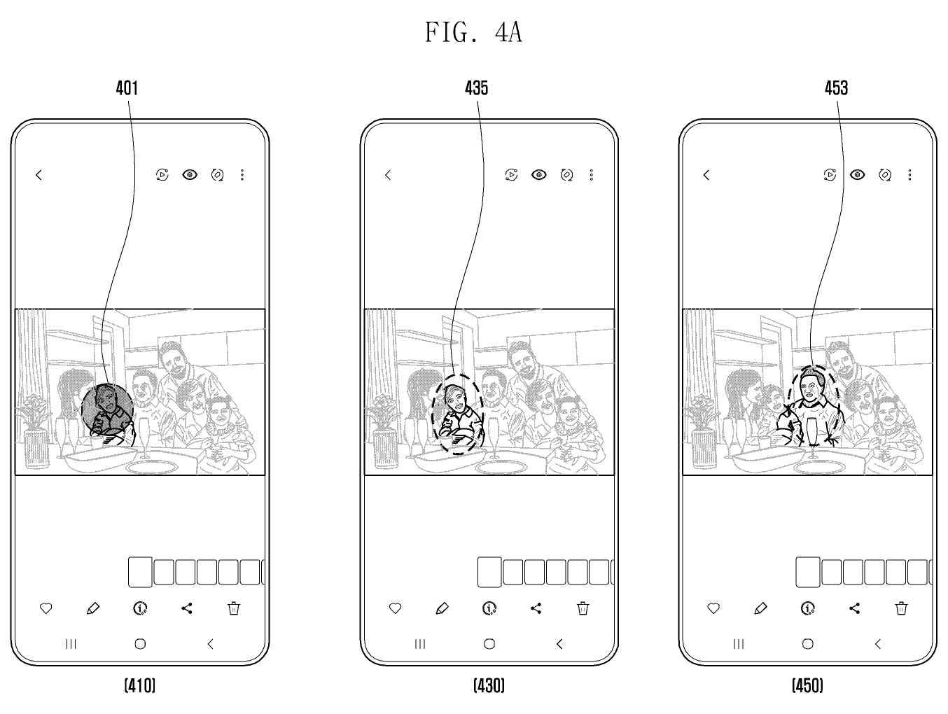

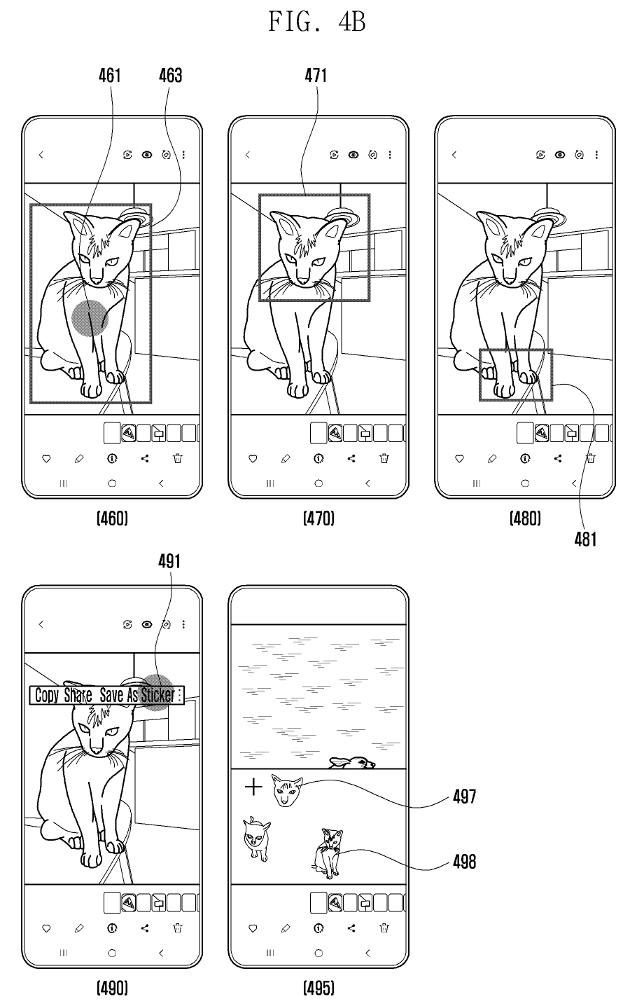

FIG. 4A is a diagram illustrating an example of recognizing a plurality of objects in an electronic device according to an embodiment of the disclosure.

Referring to FIG. 4A, a processor (e.g., processor 120 of FIG. 1) of an electronic device (e.g., electronic device 101) according to an embodiment may display a first user interface 410 including an image or video on a display (e.g., display module 160 of FIG. 1). The image or video may be stored in memory (e.g., memory 130 in FIG. 1) of the electronic device 101, stored in a cloud server (e.g., server 108 in FIG. 1), downloaded from the server 108, or disclosed in the server 108. The first user interface 410 may include an image (or video) including a plurality of persons. The processor 120 may detect (or receive) a user input 401 while displaying the first user interface 410. The user input 401 may be selecting (e.g., touching) a point on the displayed image (or video). Alternatively, the user input 401 may be an input for selecting at least one object (e.g., young child) among the objects included in the displayed image. Alternatively, the user input 401 may include an input for selecting a menu item such as editing, storing, or canceling an image or video.

The processor 120 may recognize, based on the user input 401, a plurality of objects from the displayed image. For example, the processor 120 may recognize a plurality of objects, each of which includes one, two, three, five, or six persons, from the first user interface 410. The plurality of persons may be a plurality of objects. The processor 120 may separate one or multiple objects from the plurality of objects. For example, the processor 120 may separate a first object 435 from the plurality of objects, as shown in a second user interface 430. Alternatively, the processor 120 may separate a second object 453 from the plurality of objects, as shown in a third user interface 450. Alternatively, the processor 120 may provide the second user interface 430 in response to a user input for selecting the first object 435. The processor 120 may provide the third user interface 450 in response to a user input for selecting the second object 453.

The processor 120 may display the remaining objects other than the selected object so as to be visually distinguishable. For example, the processor 120 may display the remaining objects to be blurred as compared to the selected object, or perform dim or blur processing thereon, or change the transparency thereof to a higher (or lower) level.

According to an embodiment, when a user input for reselecting the selected object is detected, the processor 120 may cancel the selection of the object. In addition, when a user input for selecting the second object 453 is detected within a predetermined time, in a state in which the first object 435 is selected, the processor 120 may select the first object 435 and the second object 453 together.

FIG. 4B illustrates an example of separating a single object into a plurality of objects in an electronic device according to an embodiment of the disclosure.

Referring to FIG. 4B, the processor 120 may display a fourth user interface 460 including an image or video on the display module 160. The fourth user interface 460 may include a cat image (or video). The processor 120 may detect a user input 461 while displaying the fourth user interface 460. The user input 461 may be selecting (e.g., touching) a point on the displayed image (or video). The processor 120 may recognize an object from the image based on the user input 461, and may determine whether the recognized object is a single object or a plurality of objects. The processor 120 may divide the recognized object into a plurality of regions of interest. The processor 120 may divide a single object into a plurality of regions of interest, or even when there is a plurality of objects, the processor 120 may divide one of the plurality of objects into a plurality of regions. Alternatively, a user input for selecting a single object may be a touch input, and a user input for selecting a plurality of regions may be a long-press input.

For example, the processor 120 may distinguish a region of interest in various ways. A first method may divide a single object including a full body of a person into regions of interest so that a larger region includes a smaller region, such as face → upper body including face → full body. A second scheme may prevent the regions of interest from overlapping each other, such as face → hand → leg. The processor 120 may distinguish a region of interest according to a third method in which the first scheme and the second scheme are mixed.

The method of designating a region of interest may adjust a region of interest (e.g., rectangular region) that includes an object, or automatically change, based on a user input, a region of interest that includes an object. For example, when a region of interest including a face is long-pressed, the region of interest may be changed in the order of a face → upper body → full body at regular time intervals, and a region of interest including an object at the time of release of a finger may be selected. Alternatively, the processor 120 may select a plurality of regions by using a method of designating a region of interest.

A plurality of pieces of clipping data of the same object selected in the above-described manner may be grouped and stored, and when clipping data is retrieved, clipping data may be changed to another clipping data based on a user input.

For example, the processor 120 may distinguish a face region 471 from a single object (e.g., cat), as shown in a fifth user interface 470. Alternatively, the processor 120 may distinguish a paw region 481 from the single object (e.g., cat) as shown in a sixth user interface 480. That is, the processor 120 may distinguish the face region 471, the paw region 481, or a full body 463 of the cat from the single object (e.g., cat). The processor 120 may provide a seventh user interface 490 based on the user input 461. The seventh user interface 490 may provide a menu item such as copy, share, edit, or data generation with respect to the displayed image. When an item 491 related to data generation is selected by a user on the seventh user interface 490, the processor 120 may provide an eighth user interface 495 in which clip data is generated using a cat image.

The processor 120 may generate first clipping data 497 including only the face of the cat, or may generate second clipping data 498 including the full body of the cat. According to an embodiment, when generating the clipping data, the processor 120 may adjust at least one of a size, location, angle, or shape of an object. Alternatively, the processor 120 may change the expression or pose of the object and may regenerate a cut-out portion of the object via out painting to generate clipping data.

According to an embodiment, the processor 120 may generate clipping data by analyzing an image or video stored in the memory 130 or stored in the server 108 in the same category. For example, the processor 120 may analyze an image or video stored in the memory 130 or the server 108, analyze an object similar to a cat object, and automatically separate a cat image to generate clipping data.

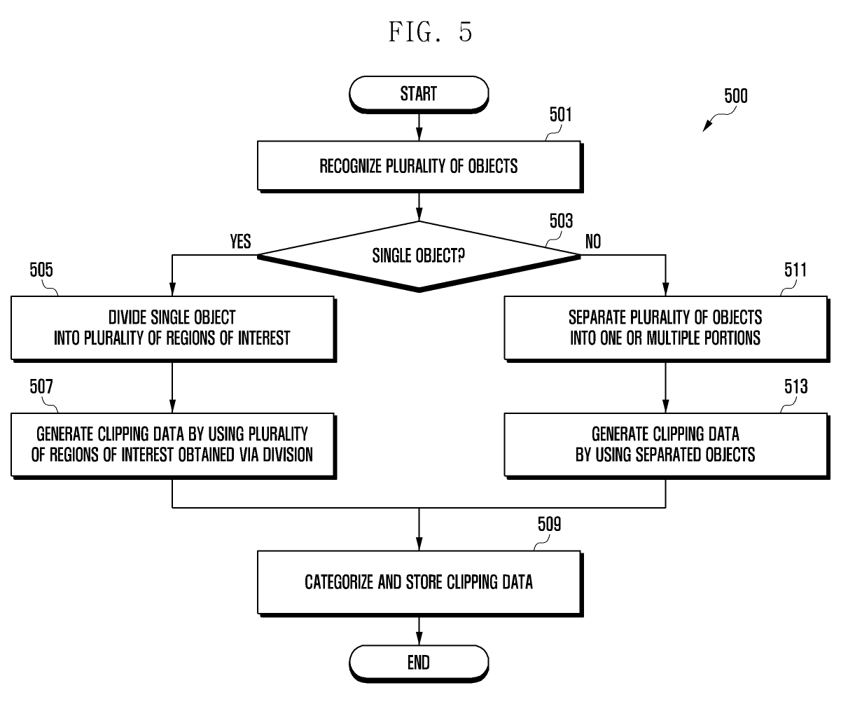

FIG. 5 is a flowchart illustrating a clipping data generation method of an electronic device according to an embodiment of the disclosure. It more specifically illustrates the flowchart in FIG. 3.

Referring to FIG. 5, flowchart 500 illustrates that, in operation 501, a processor (e.g., processor 120 of FIG. 1) of an electronic device (e.g., electronic device 101) according to an embodiment may recognize an object. The processor 120 may recognize an object from an image or video displayed on a display (e.g., display module 160 of FIG. 1). The image or video may be stored in memory (e.g., memory 130 in FIG. 1) of the electronic device 101, stored in a cloud server (e.g., server 108 in FIG. 1), downloaded from the server 108, or disclosed in the server 108. The object may include at least one of a person, a thing, an animal, or a background. The processor 120 may recognize an object from an image (or video) based on a user input (e.g., editing request, object selection), or may recognize an object from an image displayed on the display module 160, irrespective of a user input.

In operation 503, the processor 120 may determine whether the recognized object is a single object. The recognized object may be one of a person, a thing, an animal, or a background, or at least one of a person, a thing, an animal, or a background. That is, the recognized object may include a person and a thing, may include one person, may include multiple persons, or may include a person and an animal. The processor 120 may proceed with operation 505 when the recognized object is a single object, and may proceed with operation 511 when the recognized object is not a single object (e.g., a plurality of objects).

When the recognized object is a single object, the processor 120 may divide the single object into a plurality of regions of interest in operation 505. For example, when one person (e.g., upper body) is included in the displayed image, the processor 120 may divide the one person into two regions of interest, a face or a whole (e.g., entire upper body), or divide the one person into three regions of interest, a face, a face to a shoulder, or a whole (e.g., entire upper body). Alternatively, when an animal (e.g., full body) is included in the displayed image, the processor 120 may divide the animal into two regions of interest, a face or a full body, or may divide the animal into three regions of interest, a face, a tail, or a full body.

In operation 507, the processor 120 may generate clipping data from a plurality of regions of interest obtained via division. The clipping data may be a sticker, emoji, emoticon, or the like. The clipping data may include an image (e.g., still image) or video (e.g., moving image). For example, the processor 120 may generate first clipping data that includes only the face of a person, and second clipping data that includes the upper half of the person. Alternatively, the processor 120 may generate first clipping data including only the face of an animal, second clipping data including only the tail of the animal, and third clipping data including the full body of the animal.

In operation 509, the processor 120 may categorize and store the clipping data. The processor 120 may perform operation 509 after performing operation 507 or operation 513. The processor 120 may classify the clipping data based on metadata, and store the same in the memory 130. The metadata may refer to metadata of an image (or video) including the plurality of recognized objects. The metadata may include at least one of a date, time, and location at which the image is generated (or captured, downloaded, or edited). Alternatively, the processor 120 may utilize data (e.g., friend, domestic travel, overseas travel) obtained via object analysis or image analysis as the metadata. The processor 120 may classify and store the generated clipping data as one of a cat, a dog, and a pig. Alternatively, the processor 120 may classify and store the generated clipping data, for example, as a user, family, or lover. Alternatively, the processor 120 may classify and store the generated clipping data, for example, as a first location (e.g., New York Times Square), a second location (e.g., New York Chinatown), and a third location (e.g., New York SoHo street).

When the recognized object is not a single one (e.g., a plurality of objects), the processor 120 may separate one or multiple objects from a plurality of objects, in operation 511. According to an embodiment, the processor 120 may analyze the plurality of recognized objects, and separate one or multiple objects from the plurality of objects, based on the analyzed result. For example, the processor 120 may analyze metadata of the image including the plurality of recognized objects, image or video stored in the memory 130, or image or video stored (or registered) in the server 108 in association with a user of the electronic device 101. For example, the processor 120 may separate one object from the plurality of objects, or may separate one object including two or more objects.

In operation 513, the processor 120 may generate clipping data based on the separated object. For example, the processor 120 may generate one piece of clipping data from one object, or generate one piece of clipping data from a plurality of objects. Alternatively, the processor 120 may generate clipping data from a plurality of regions of interest.

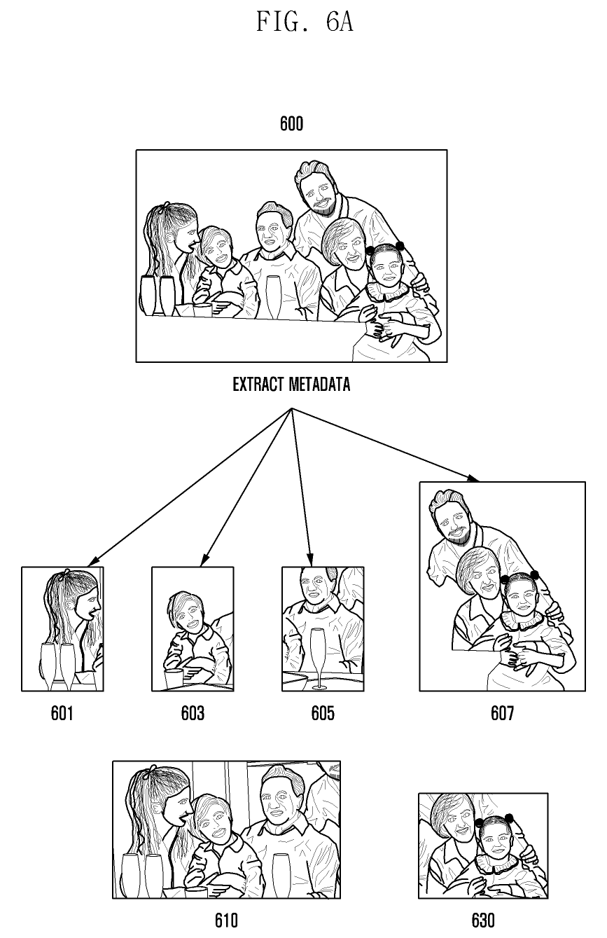

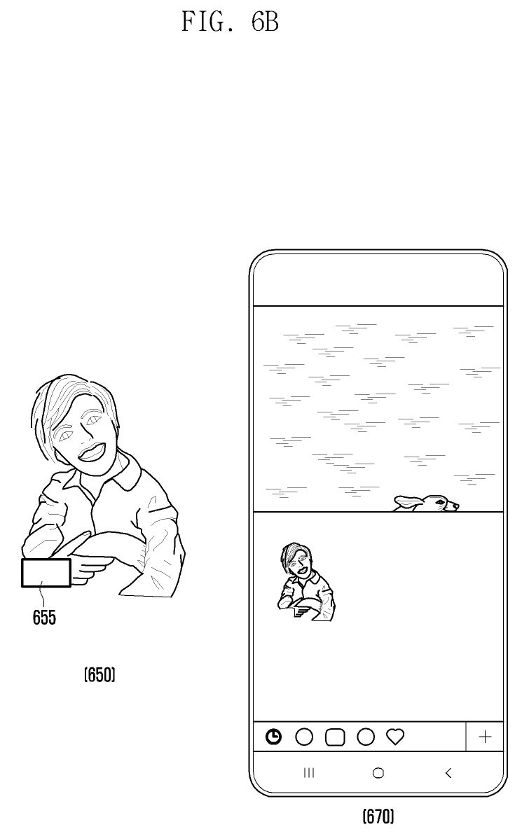

FIG. 6A is a diagram illustrating an example of generating clipping data in an electronic device according to an embodiment of the disclosure.

Referring to FIG. 6A, a processor (e.g., processor 120 of FIG. 1) of an electronic device (e.g., electronic device 101) according to an embodiment may extract metadata of an image (or video) 600 displayed on a display (e.g., display module 160 of FIG. 1) when generating clipping data from the image. The metadata may include at least one of a date, time, and location at which the image is generated (or captured, downloaded, or edited). Alternatively, the processor 120 may utilize data (e.g., similar time, same place, and same person) obtained via object analysis or image analysis as the metadata. The processor 120 may analyze the image (or video) 600, recognize an object from the image (or video) 600, and generate, based on the metadata of the image (or video) 600, first clipping data 601, second clipping data 603, third clipping data 605, fourth clipping data 607, fifth clipping data 610, or sixth clipping data 630. The first clipping data 601 to third clipping data 605 may be a single object, and fourth clipping data 607 to sixth clipping data 630 may include a plurality of objects. The processor 120 may generate the fourth clipping data 257 to the sixth clipping data 630 by grouping adjacent objects.

FIG. 6B is a diagram illustrating an example of correcting an object and generating clipping data in an electronic device according to an embodiment of the disclosure.

Referring to FIG. 6B, the processor 120 may determine whether a part hidden (or cut) by another object exists when generating clipping data, and may correct (or generate) the hidden part. For example, the processor 120 may generate a cut region 655 of an object 650 to generate clipping data. The processor 120 may categorize only clipping data generated via out-painting and provide the same to a user interface 670. According to an embodiment, when generating the clipping data, the processor 120 may adjust at least one of a size, location, angle, or shape of an object. Alternatively, the processor 120 may change the expression or pose of the object and may generate a cut portion of the object via out-painting, so as to generate the clipping data.

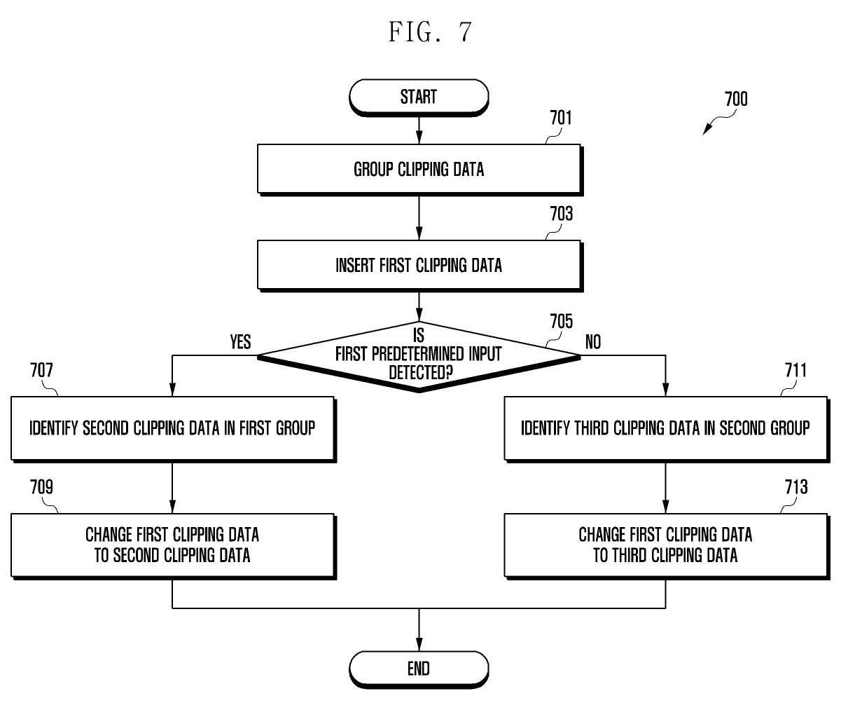

FIG. 7 is a flowchart illustrating a method of utilizing clipping data of an electronic device according to an embodiment of the disclosure.

Referring to FIG. 7, flowchart 700 illustrates that, in operation 701, a processor (e.g., processor 120 of FIG. 1) of an electronic device (e.g., electronic device 101) according to an embodiment may group clipping data. Grouping may refer to putting clipping data having the same or similar metadata together. For example, the processor 120 may group clipping data obtained from the same (or similar) location (e.g., California), may group clipping data corresponding to the same person, or may group clipping data corresponding to the upper body (or face) of the same person. The processor 120 may group and store the clipping data.

In operation 703, the processor 120 may insert first clipping data. For example, the processor 120 may insert (or add, combine) the first clipping data into an image displayed in an image (or video) editing application. Alternatively, the processor 120 may insert the first clipping data into an image (or video) displayed on a display (e.g., display module 160 of FIG. 1).

In operation 705, the processor 120 may determine whether a first predetermined input is detected. The first predetermined input is a user input detected on the inserted first clipping data, and may be a touch input for swiping (or dragging, scrolling) in the horizontal direction (e.g., left → right, right → left). When the first predetermined input is detected, the processor 120 may perform operation 707, and when the first predetermined input is not detected, the processor 120 may perform operation 711.

In the drawings, in the case in which the first predetermined input is not detected, it is described that a second predetermined input is detected. For inputs (e.g., selecting a cancel button, an edit button, or a save button) other than the first predetermined input or the second predetermined input, a function corresponding to the input may be performed. A process of inserting and then storing (or canceling or editing) clipping data corresponds to conventional art, and thus a detailed description may be omitted.

When the first predetermined input is detected, the processor 120 may identify second clipping data in a first group, in operation 707. For example, the first group may be a group to which the first clipping data belongs, and for example, may correspond to the same person (e.g., child's photo). The second clipping data may be included in the first group to which the first clipping data belongs, but may be different from the first clipping data.

According to an embodiment, a group in which the second clipping data is identified may vary according to the direction of a swipe that moves horizontally. For example, when a left-to-right swipe is performed, the processor 120 may identify the second clipping data in the first group. For example, when a right-to-left swipe is performed, the processor 120 may identify the second clipping data in a third group. The third group may be a group different from the first group and may correspond to the upper body of a person. The third group may be a group in which clipping data respectively corresponding to the upper bodies of different persons are put together.

In operation 709, the processor 120 may change the first clipping data to the second clipping data. The processor 120 may change a user interface into which the first clipping data is inserted to a user interface into which the second clipping data is inserted, and display the same. That is, the processor 120 may provide the user interface into which the second clipping data is inserted, instead of the first clipping data.

When the first predetermined input is not detected, the processor 120 may identify third clipping data in a second group, in operation 711. In the drawings, in the case in which the first predetermined input is not detected, it is described that the second predetermined input is detected. The second predetermined input is a user input detected on the inserted first clipping data, and may be a touch input swiping (or dragging, scrolling) in the vertical direction (e.g., up → down, down → up). For example, the second group may be a group to which the first clipping data belongs, and may correspond to, for example, the same location. The third clipping data may be included in the second group to which the first clipping data belongs, but may be different from the first clipping data.

In operation 713, the processor 120 may change the first clipping data to the third clipping data. The processor 120 may change a user interface into which the first clipping data is inserted to a user interface into which the third clipping data is inserted, and display the same. That is, the processor 120 may provide the user interface into which the third clipping data is inserted, instead of the first clipping data.

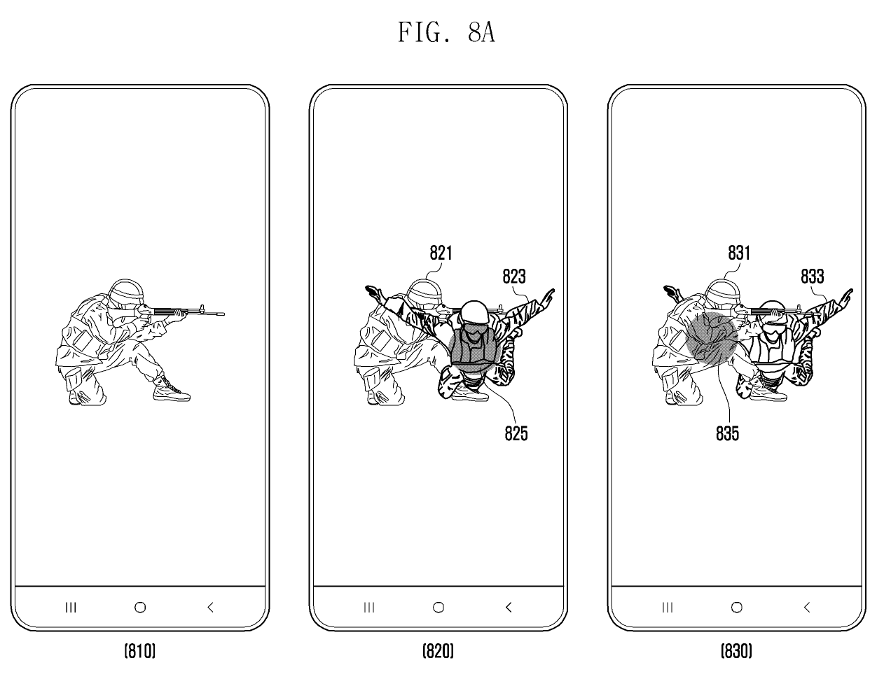

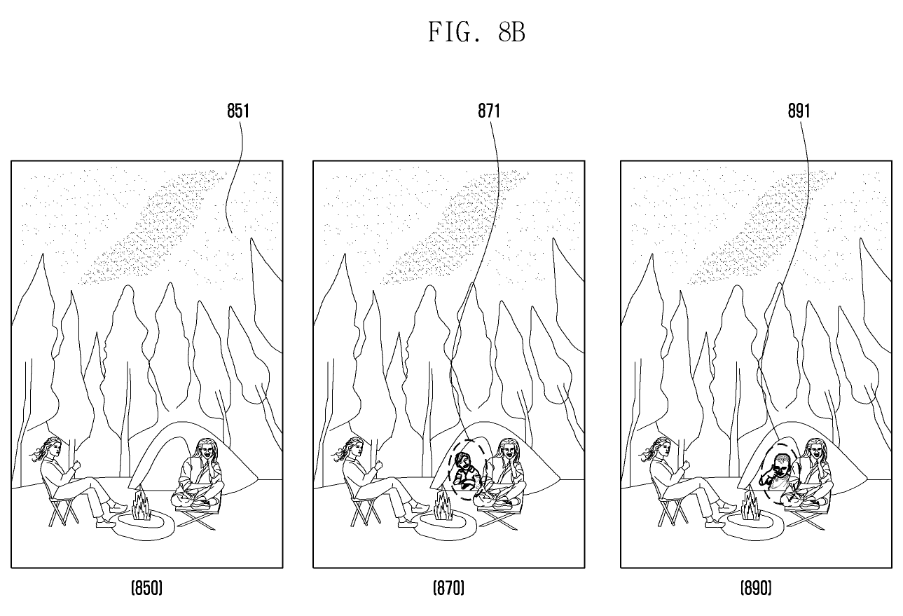

FIGS. 8A and 8B are diagrams illustrating an example of inserting clipping data in an electronic device according to various embodiments of the disclosure.

Referring to FIG. 8A, a processor (e.g., processor 120 of FIG. 1) of an electronic device (e.g., electronic device 101) according to an embodiment may display a first user interface 810 including an image or video on a display (e.g., display module 160 of FIG. 1). An image (or video) into which clipping data is to be inserted is selected by a user, and then the processor 120 may display the selected image as shown in the first user interface 810. The processor 120 may select clipping data to be inserted, and then an image into which the selected clipping data is to be inserted may be selected. The processor 120 may provide a second user interface 820 or a third user interface 830 in response to a request for inserting clipping data. The second user interface 820 may be a result of inserting clipping data 823 into a displayed image 821 (e.g., a layer on the image).

When the processor 120 detects a touch 825 by the user on the clipping data 823, the processor 120 may insert the clipping data 823 into the displayed image 821, as shown in the second user interface 820. Alternatively, the third user interface 830 may be a result of inserting clipping data 833 under a displayed image 831 (e.g., a layer under the image). When the processor 120 detects a touch 835 by the user on the displayed image 831, the processor 120 may insert the clipping data 833 under the displayed image 831 as shown in the third user interface 830.

According to an embodiment, when inserting the clipping data, the processor 120 may analyze (e.g., metadata) the displayed image to adjust at least one of a size, location, angle, or shape of the clipping data. For example, the processor 120 may adjust the size of the clipping data to be smaller or larger according to an object included in the displayed image, or may place the clipping data to the left or right of the object. According to an embodiment, the processor 120 may receive, from the user, an input of selecting a region into which clipping data is to be inserted into the displayed image. Alternatively, the processor 120 may insert clipping data into a designated region of the displayed image by analyzing the displayed image without a user input.

Referring to FIG. 8B, the processor 120 may display a fourth user interface 850 including an image or video on the display module 160. The processor 120 may provide a fifth user interface 870 in response to a request for inserting clipping data. The fifth user interface 870 may include first clipping data 871. The processor 120 may receive, from a user, an input of selecting a region into which the first clipping data 871 is to be inserted into a displayed image 851. Alternatively, the processor 120 may insert the first clipping data 871 by analyzing the displayed image.

The processor 120 may provide a sixth user interface 890 when a first predetermined input is detected on the first clipping data 871. The first predetermined input may be an input for changing the first clipping data with another clipping data in the same group as that of the first clipping data, and for example, the first predetermined input may include a swipe input in a first predetermined direction, but is not limited thereto. The sixth user interface 890 may include second clipping data 891. The processor 120 may identify second clipping data 891 within a first group to which the first clipping data 871 belongs, and may provide the sixth user interface 890 in which the first clipping data 871 is changed to the second clipping data 891 instead. Based on the first predetermined input, the second clipping data 891 may be a child photo different from the first clipping data 871. For example, when a second predetermined input is detected, the processor 120 may insert a different photo of the child same as that of the first clipping data 871, as second clipping data. The second predetermined input may be an input for changing the first clipping data with another clipping data in the same group as that of the first clipping data, and for example, the second predetermined input may include a swipe input in a second predetermined direction, but is not limited thereto. The second predetermined direction may be different (e.g., opposite direction) from the first specified direction.

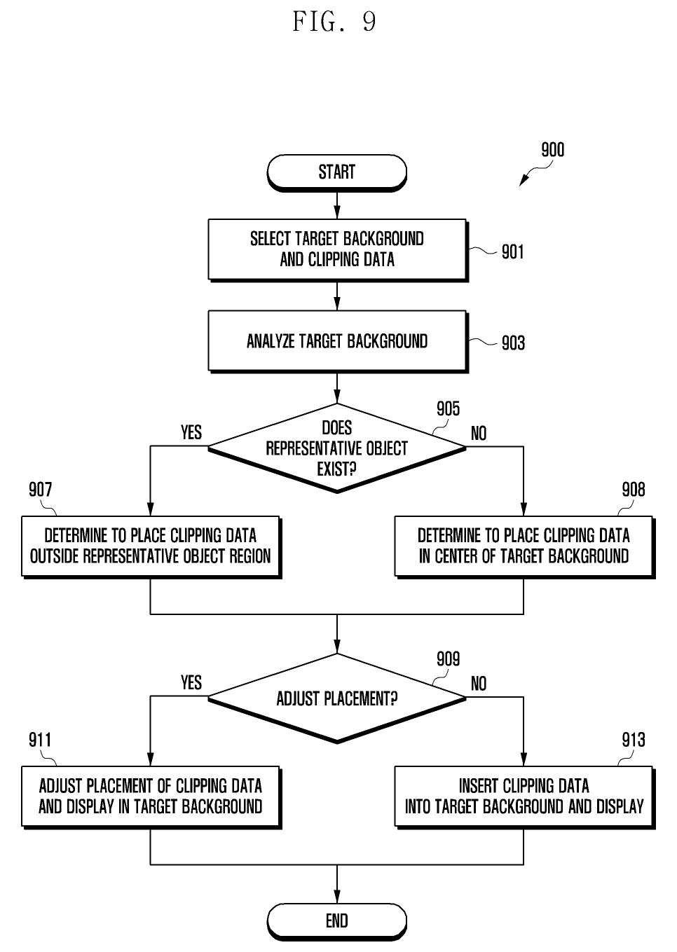

FIG. 9 is a flowchart illustrating a clipping data merging method of an electronic device according to an embodiment of the disclosure.

Referring to FIG. 9, flowchart 900 illustrates that, in operation 901, a processor (e.g., processor 120 of FIG. 1) of an electronic device (e.g., electronic device 101) according to an embodiment may select a target background and clipping data. The target background may refer to an image or video to which the clipping data is to be inserted. The target background may include one or more objects.

In operation 903, the processor 120 may analyze the target background. The processor 120 may analyze an image (or video) of the target background, or recognize an object included in the target background.

In operation 905, the processor 120 may determine whether a representative object exists in the target background. The representative object may be a person. Alternatively, the representative object may be configured to a thing or an animal. When a representative object exists in the target background, the processor 120 may perform operation 907, and when no representative object exists in the target background, the processor 120 may perform operation 908.

When a representative object exists in the target background, the processor 120 may determine that clipping data is placed outside a representative object region, in operation 907. For example, when the representative object is located in the center of the image, the processor 120 may determine to place the clipping data in a location adjacent to the representative object. Alternatively, based on the representative object or the selected clipping data, the processor 120 may place the clipping data in a different manner. For example, when the representative object is a person and the selected clipping data is an animal, it may be determined to place the selected clipping data to the left of the representative object. Alternatively, when the representative object is a thing (e.g., car) and the selected clipping data is a person, the processor 120 may determine to place the selected clipping data below the representative object. Such examples are for the purpose of helping understanding of the disclosure, and the disclosure is not limited by the examples.

When no representative object exists in the target background, the processor 120 may determine to place the clipping data in the center of the target background, in operation 908. When the target background is sand, a forest, or the sea, the processor 120 may place the clipping data in the center of the target background.

In operation 909, the processor 120 may determine whether the placement of the clipping data needs to be adjusted. Based on the target background and the selected clipping data, the processor 120 may adjust at least one of a size, location, angle, or shape of the clipping data. When the placement of the clipping data needs to be adjusted, the processor 120 may perform operation 911, and when the placement of the clipping data does not need to be adjusted, the processor 120 may perform operation 913.

When the placement of the clipping data needs to be adjusted, the processor 120 may adjust the placement of the clipping data and display the same in the target background, in operation 911. For example, the processor 120 may adjust the size of the clipping data to be smaller or larger according to the target background, may adjust a location where the clipping data is placed, or may adjust the angle (e.g., angular direction) of the clipping data to face the representative object.

When the placement of the clipping data does not need to be adjusted, the processor 120 may insert the selected clipping data into the target background and display the same, in operation 913. The processor 120 may adjust, based on a user input, the placement of the selected clipping data. The user may identify the clipping data inserted into the target background and may adjust the placement of the clipping data.

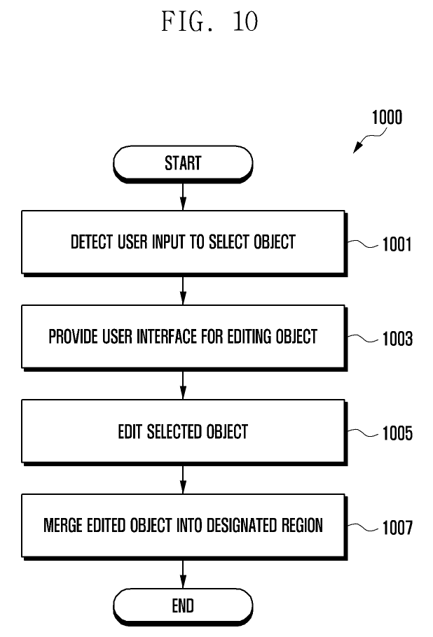

FIG. 10 is a flowchart illustrating an object editing method of an electronic device according to an embodiment of the disclosure.

Referring to FIG. 10, flowchart 1000 illustrates that, in operation 1001, a processor (e.g., processor 120 of FIG. 1) of an electronic device (e.g., electronic device 101) according to an embodiment may detect a user input for selecting an object. The processor 120 may recognize an object from an image or video displayed on a display (e.g., display module 160 of FIG. 1), and may detect a user input for selecting at least one of the recognized objects. Alternatively, the processor 120 may recognize an object, and display the object differently for each recognized object. For example, the processor 120 may display a boundary of the recognized object for each object. The processor 120 may detect a user input to request editing the object via a menu item, or may receive a user input for selecting and editing the object.

In operation 1003, the processor 120 may provide a user interface for editing the object. The processor 120 may execute an application associated with image (or video) editing, and display an execution screen of the application including the object.

In operation 1005, the processor 120 may edit the selected object. The processor 120 may edit the selected object based on a user input. The processor 120 may edit, based on the user input, at least one of a size, location, angle, or shape of the selected object.

In operation 1007, the processor 120 may merge the edited object into a designated region. The designated region may be selected by a user. Alternatively, the processor 120 may determine a region into which the edited object is to be merged by analyzing an image or video into which the edited object is to be merged. For example, the processor 120 may rearrange some of a plurality of objects. Based on the edited object, the processor 120 may rearrange the edited object in the image or video into which the edited object is to be merged, and store the same together with the metadata thereof in the memory (e.g., memory 130 of FIG. 1).

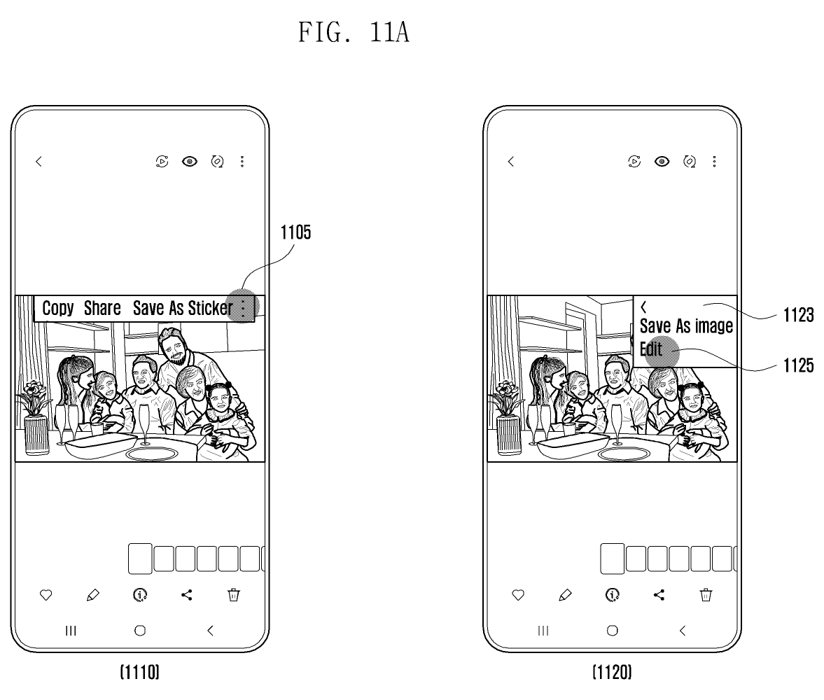

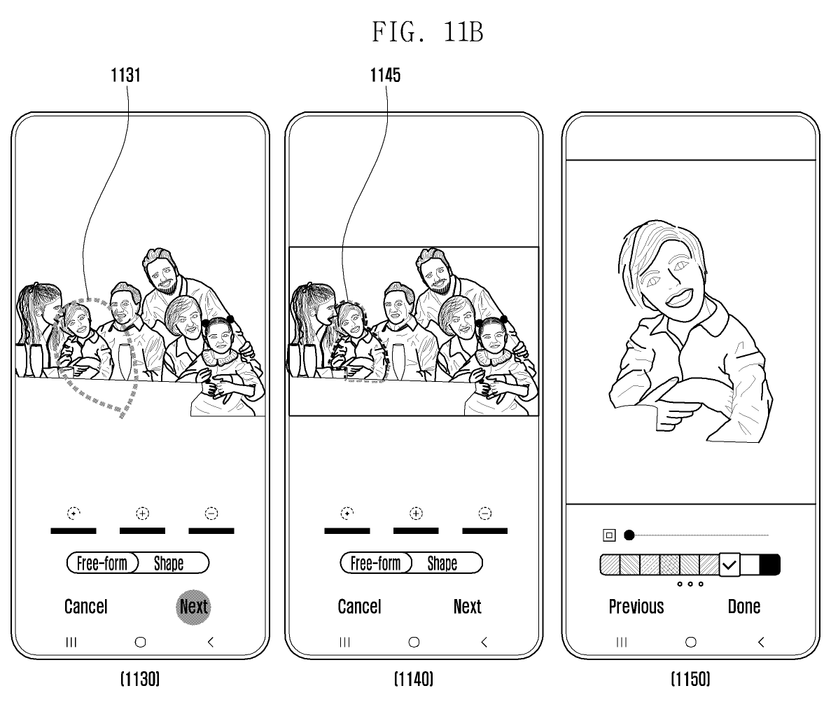

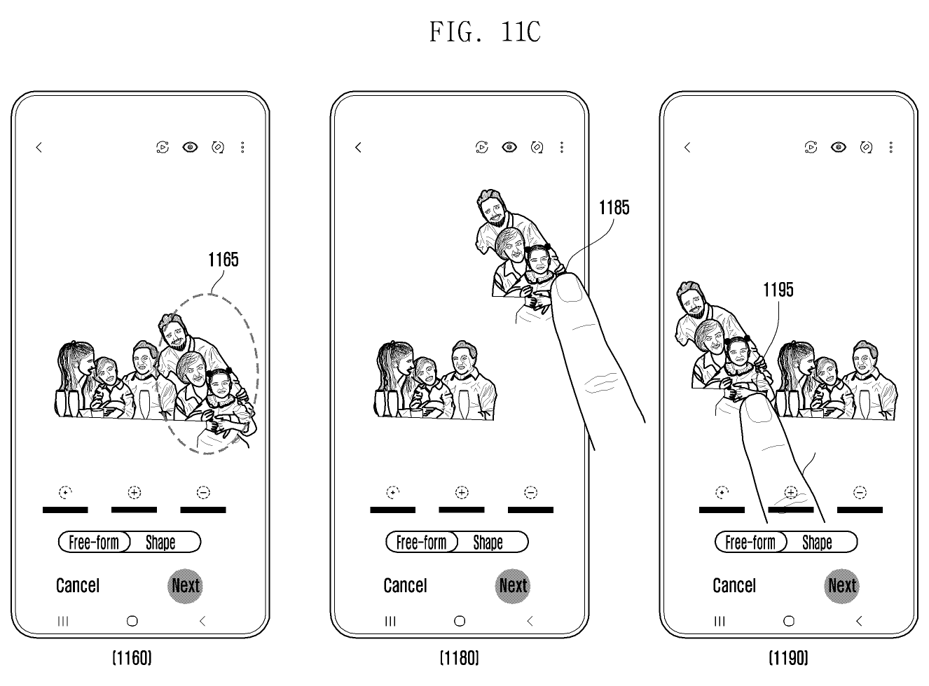

FIGS. 11A to 11C are diagrams illustrating examples of editing an object in an electronic device according to various embodiments of the disclosure.

Referring to FIG. 11A, a processor (e.g., processor 120 of FIG. 1) of an electronic device (e.g., electronic device 101) according to an embodiment may display a first user interface 1110 including an image or video on a display (e.g., display module 160 of FIG. 1). The processor 120 may detect a user input 1105 for selecting "more" from a menu item in the first user interface 1110. The processor 120 may display a second user interface 1120 based on the user input 1105. The second user interface 1120 may further provide a data generation item or an editing item as a menu item 1123 on a displayed image (or video). The processor 120 may detect a user input 1125 for selecting an editing item from the menu item 1123 of the second user interface 1120.

Referring to FIG. 11B, based on the user input 1125, the processor 120 may provide a third user interface 1130 or a fourth user interface 1140 for editing an object. The user may select an object to be edited among a plurality of objects via the third user interface 1130 or the fourth user interface 1140. The processor 120 may receive a user input 1131 that draws an object to be edited on the third user interface 1130. The processor 120 may receive a user input 1145 that taps on an object to be edited on the fourth user interface 1140. When the object to be edited is selected, the processor 120 may provide a fifth user interface 1150. The processor 120 may edit the selected object based on a user input via the fifth user interface 1150.

Referring to FIG. 11C, the processor 120 may receive a user input 1165 that taps on an object to be edited among a plurality of objects, such as a sixth user interface 1160. The processor 120 may receive a user interaction 1185 for moving a location of the selected object as shown in a seventh user interface 1180. The processor 120 may provide an eighth user interface 1190 in which the selected object selected is moved from the left to the right according to a user interaction 1195. Based on the user interaction 1195, the processor 120 may edit at least one of a size, location, angle, or shape of the selected object.

According to an embodiment, there may be various object editing methods. The size of the object may be changed by pinching in/out the selected object or by using a rectangular region circumscribed when the object is selected. The angle may be changed by rotating the selected object in the state of multi-touching the selected object or by selecting a rotation icon and rotating. The location may be changed by a touch and drag input, and all of these values may be changed by entering values in the properties. According to an embodiment, when merging the edited object, the processor 120 may adjust at least one of a size, location, angle, or shape of the edited object. Based on the edited object, the processor 120 may rearrange the edited object in the image or video into which the edited object is to be merged, and store the same together with the metadata thereof in the memory (e.g., memory 130 of FIG. 1).

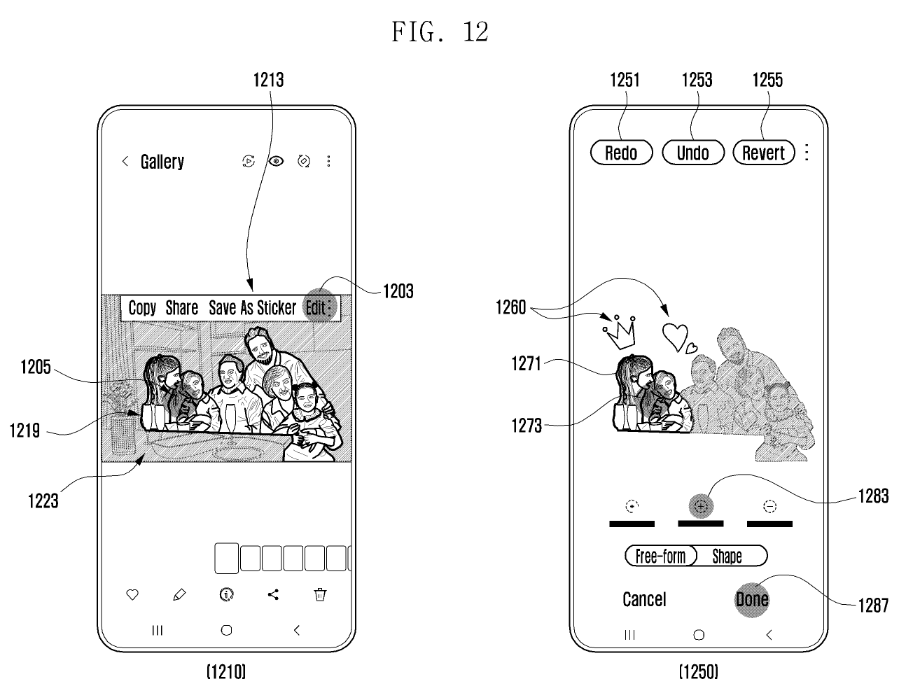

FIG. 12 is a diagram illustrating an example of generating, editing, and utilizing clipping data from a selected image in an electronic device according to an embodiment of the disclosure.

Referring to FIG. 12, a processor (e.g., processor 120 of FIG. 1) of an electronic device (e.g., electronic device 101) according to an embodiment may select an image to generate clipping data (e.g., sticker) from a gallery application, generate clipping data from the selected image, edit the clipping data, and utilize the clipping data (e.g., using as an emoticon insertable into a message).

A first user interface 1210 may be an execution screen (e.g., gallery interface) of the gallery application for selecting and displaying an image to generate clipping data in the gallery application. The processor 120 may recognize and separate an object 1223 including six persons, based on a user input 1205 for selecting an object 1219 in the image. The user input 1205 for selecting the object 1219 may include a touch, a multi-touch, or a swipe, but is not limited thereto. The processor 120 may perform at least one function related to the object via a menu 1213 displayed adjacent to the recognized object (region of interest). Based on a user input 1203 for selecting an edit item of the provided menu 1213, the processor 120 may provide an editing interface that is capable of editing the object.

A second user interface 1250 may be an editing interface, and may include an editing menu 1251, 1253, or 1255. In the state in which a manual selection item (select manually) 1283 is selected, the processor 120 may recognize/separate a selected object 1271 from the object including the plurality of persons based on a user input 1273, and may insert a custom decoration sticker 1260 further provided. The processor 120 may automatically recognize the inserted custom decoration sticker and photo sticker, and add them as a composite sticker. Upon receiving a user input 1287 for selecting an editing completion button, the processor 120 may complete the editing, and may store finally edited clipping data (e.g., composite photo sticker including custom decoration sticker).

According to an embodiment, based on the edited object, the processor 120 may rearrange the edited object in an image or a video to which the edited object is to be merged, and store the same together with metadata of the image or video in memory (e.g., memory 130 in FIG. 1).

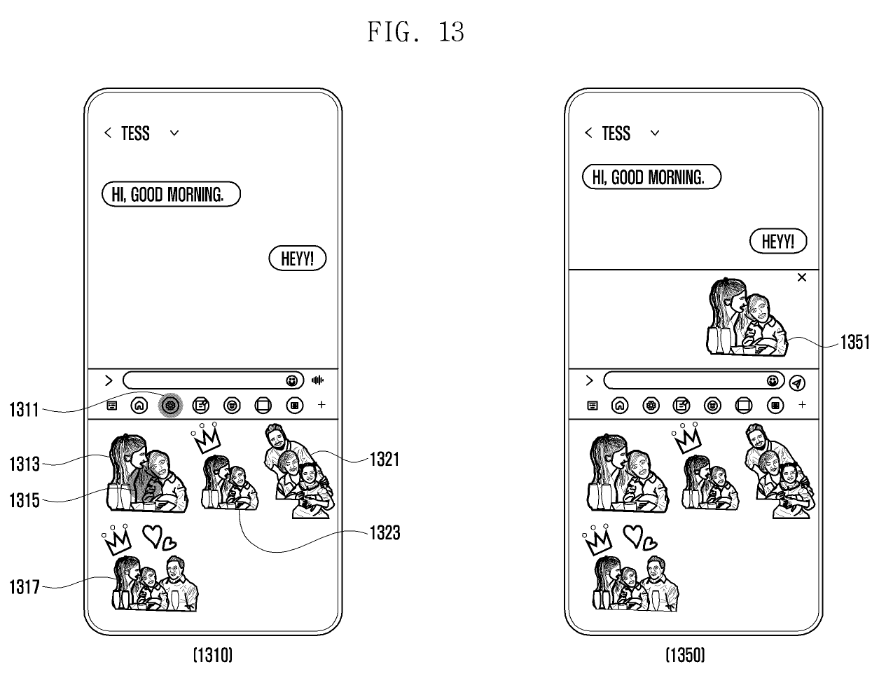

FIG. 13 is a diagram illustrating an example of generating, editing, and utilizing clipping data from a selected image in an electronic device according to an embodiment of the disclosure.

Referring to FIG. 13, a processor (e.g., processor 120 of FIG. 1) of an electronic device (e.g., electronic device 101) according to an embodiment may provide a first user interface 1310 as a screen for utilizing (or sharing) clipping data. The first user interface 1310 may include an execution screen of a message application. Based on a user input 1311 for selecting a gallery application icon in the first user interface 1310, generated/edited clipping data (photo sticker, compound sticker) 1313, 1323, 1321, and 1317 may be provided.

Based on a user input 1315 for selecting the clipping data 1313 to be shared, the processor 120 may provide a second user interface 1350. The processor 120 may display selected clipping data 1351, and may share (transmit) the clipping data when a user input for sharing the clipping data 1351 is received. The second user interface 1350 may include an execution screen of a message application that transmits the clipping data 1351.

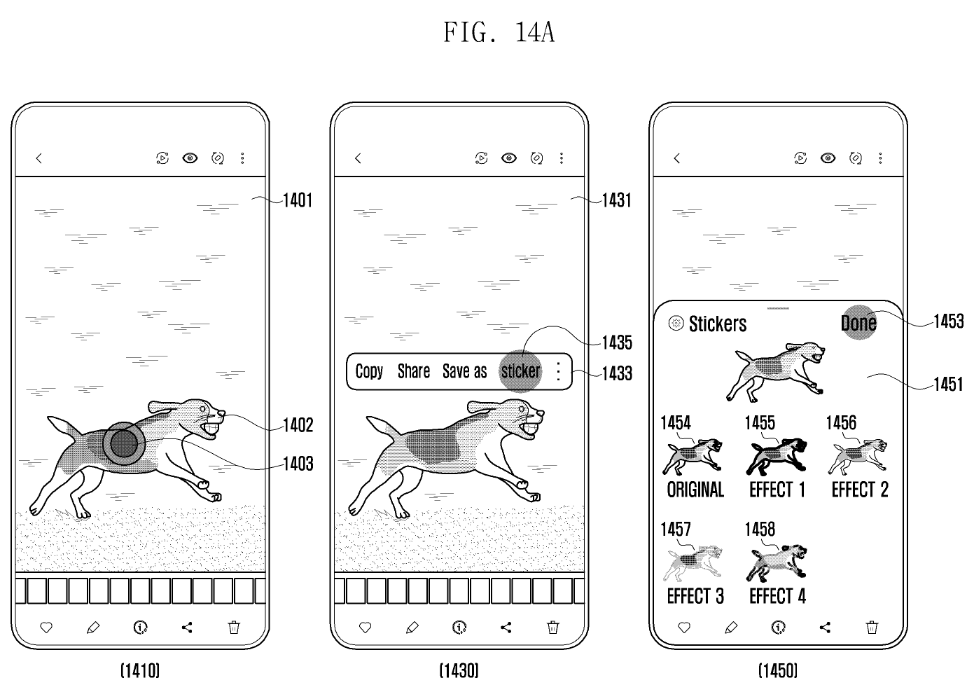

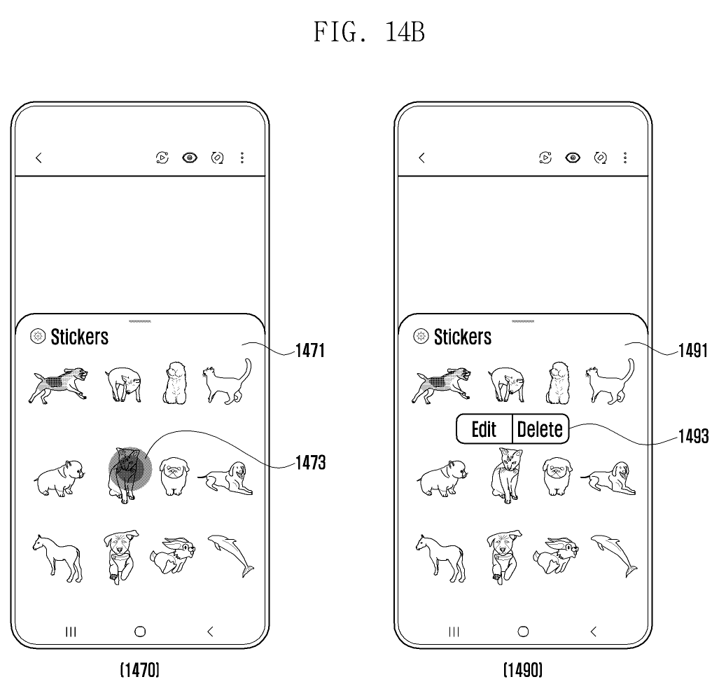

FIGS. 14A and 14B are diagrams illustrating an example of utilizing clipping data in an electronic device according to various embodiments of the disclosure.

Referring to FIG. 14A, a processor (e.g., processor 120 of FIG. 1) of an electronic device (e.g., electronic device 101) according to an embodiment may provide an effect item to be applied to clipping data when storing (or generating) the clipping data. The first user interface 1410 may be an image 1401 including an object 1402. The processor 120 may recognize the object 1402 in the image 1401, and may detect a user input 1403 for selecting the recognized object 1402. The processor 120 may provide a second user interface 1430 in response to detecting the user input 1403. The second user interface 1430 may include a menu item 1433 for generating (or storing) clipping data (e.g., sticker) by using the object 1402 in an image 1431. When a user input 1435 for selecting “save (save as sticker)” from the menu item 1433 is detected, the processor 120 may generate clipping data from the object 1402 and store the generated clipping data.

The processor 120 may generate clipping data 1451, and may provide at least one effect item that is applicable to the clipping data when storing the generated clipping data 1451. The processor 120 may provide at least one effect item as shown in a third user interface 1450. The at least one effect item may include at least one of an original 1454, effect 1 (e.g., outline) 1455, effect 2 (e.g., rough cut) 1456, effect 3 (e.g., vintage) 1457, or effect 4 (e.g., cartoon) 1458. The effect items illustrated in the drawing are examples for describing the disclosure, and the types of the effects are not limited to the examples in the drawing. When one of the at least one effect items is selected in the third user interface 1450, and "save (Done)" 1453 is selected, the processor 120 may store the clipping data to which the selected effect is applied.

Referring to FIG. 14B, the processor 120 may provide a clipping data list 1471 including one or more pieces of clipping data as shown in a fourth user interface 1470, and may receive an input for selecting at least one piece of clipping data from the clipping data list 1471. When the clipping data to which the effect is applied is stored, the processor 120 may enable the clipping data to which the effect is applied to be identified immediately from the clipping data list 1471. The fourth user interface 1470 may be an example in which a user input 1473 for selecting at least one piece of clipping data from the clipping data list 1471 is detected. The processor 120 may provide an editing item 1493 (e.g., edit, delete) for editing clipping data selected from a clipping data list 1491 as shown in a fifth user interface 1490.

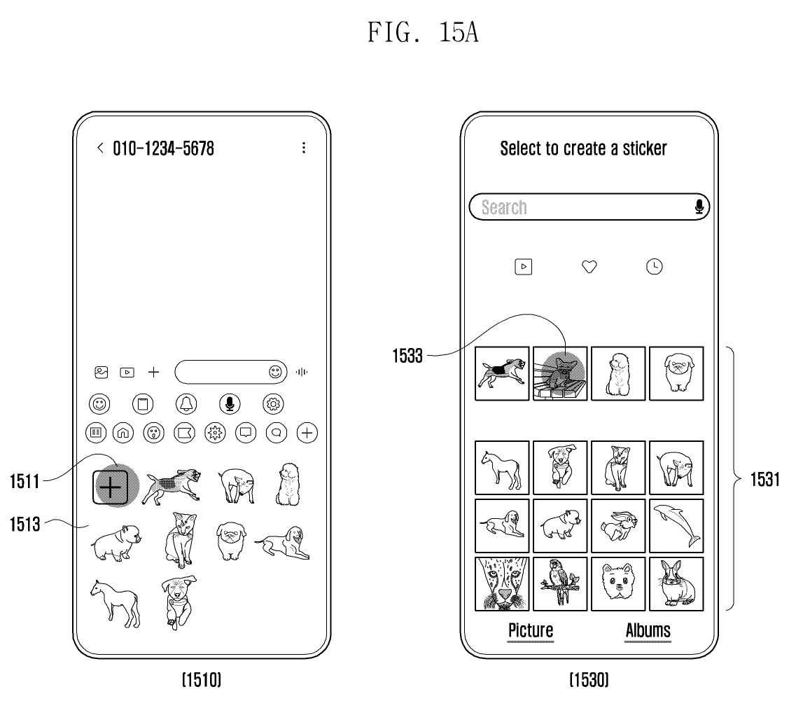

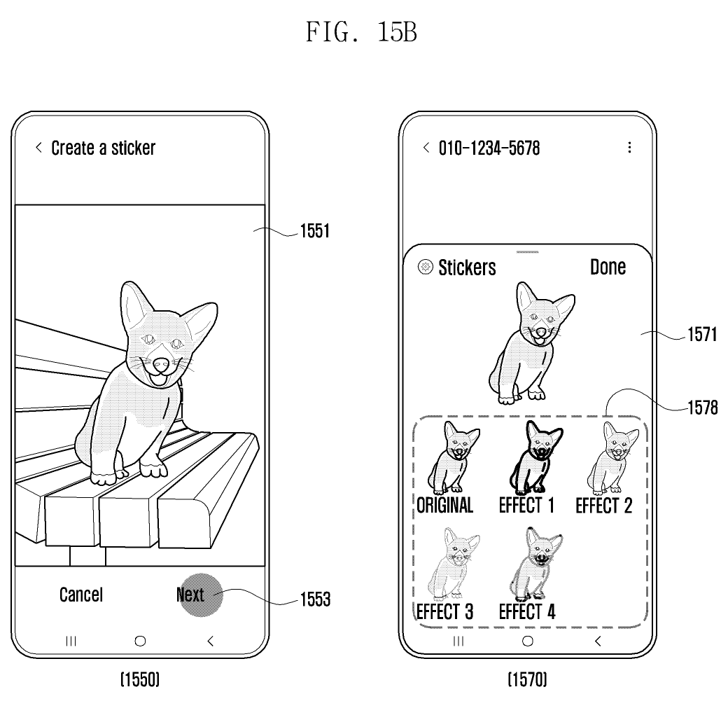

FIGS. 15A and 15B are diagrams illustrating an example of utilizing clipping data in an electronic device according to various embodiments of the disclosure.

Referring to FIG. 15A, a processor (e.g., processor 120 of FIG. 1) of an electronic device (e.g., electronic device 101) according to an embodiment may provide a first user interface 1510 including at least one piece of clipping data. The first user interface 1510 may include a clipping data list 1513 including at least one piece of clipping data based on a user request in an execution screen of a message application. On the first user interface 1510, the processor 120 may detect a user input 1511 for adding clipping data. The processor 120 may provide a second user interface 1530 in response to the user input 1511. The second user interface 1530 may provide an image list 1531 including at least one image capable of being used for generating clipping data (e.g., sticker). The processor 120 may detect a user input 1533 for selecting one of the images in the image list 1531.

Referring to FIG. 15B, the processor 120 may provide a third user interface 1550 in response to a user input 1533. The third user interface 1550 may be a result of recognizing an object to be clipped from an image selected from a gallery application, and automatically generating clipping data 1551 using the recognized object. The processor 120 may provide a fourth user interface 1570 when a next button 1553 is selected via the third user interface 1550. The fourth user interface 1570 may include clipping data 1571 and an image list 1578 in which various effects are applied to the clipping data 1571. The image list 1578 may include an original image (e.g., original) of the clipping data 1571 and an image obtained by applying at least one of an outline, rough cut, vintage, and cartoon effect to the clipping data 1571.

An operation method of the electronic device 101 according to an embodiment of the disclosure may include an operation of recognizing a plurality of objects from an image or video displayed on the display module 160 of the electronic device, an operation of, based on a user input, separating one or multiple objects from the plurality of recognized objects, an operation of generating clipping data from the separated objects, an operation of displaying the generated clipping data on the display, and an operation of storing the displayed clipping data together with metadata of the image or video including the plurality of objects, in the memory 130 of the electronic device.

The method may include an operation of detecting a second user input to select a first object, after recognizing the plurality of objects, an operation of editing, based on a third user input, the selected first object, and an operation of storing the edited first object and the plurality of objects as one object.

The editing may include an operation of editing, based on the third user input, at least one of a size, a location, an angle, or a shape of the first object.

The method may further include an operation of merging the edited first object into a designated region of the image or video.

The merging may include an operation of adjusting at least one of a size, a location, an angle, or a shape of the edited first object when merging the edited first object.

The method may further include an operation of rearranging the edited first object in the image or video based on the edited first object, and storing, in the memory, the rearranged object together with the metadata of the image or video.

The method may further include an operation of recognizing at least one of a person, a thing, an animal, or a background from the displayed image or video as one object, and, when one object is recognized, an operation of dividing the recognized object into a plurality of regions of interest and identifying the recognized object as a plurality of objects.

The method may further include an operation of grouping, based on the metadata, clipping data stored in the memory.

The method may further include an operation of detecting a first predetermined input in a state in which first clipping data is inserted, an operation of identifying second clipping data in a first group which the first clipping data belongs to, in response to the first predetermined input, and an operation of changing the first clipping data to the second clipping data.

The method may further include an operation of detecting a second predetermined input in a state in which first clipping data is inserted, an operation of identifying third clipping data in a second group which the first clipping data belongs to, in response to the second predetermined input, and an operation of changing the first clipping data to the third clipping data.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
memory, comprising one or more storage media, storing instructions; and
one or more processors communicatively coupled to the display and the memory,
wherein the instructions, when executed by the one or more processors individually or collectively, cause the electronic device to:
recognize a plurality of objects from an image or video displayed on the display,
based on a user input, separate one object or multiple objects from the plurality of objects that are recognized,
generate clipping data from the one object or multiple objects separated from the plurality of objects,
display the clipping data on the display, and
store, in the memory, the clipping data together with metadata of the image or video including the plurality of objects.

2. The electronic device of claim 1, wherein the instructions, when executed by the one or more processors individually or collectively, further cause the electronic device to:
after recognizing the plurality of objects, detect a second user input selecting a first object;
based on a third user input, edit the first object; and
store the edited first object and the plurality of objects as one object.

3. The electronic device of claim 2, wherein the instructions, when executed by the one or more processors individually or collectively, further cause the electronic device to:
based on the third user input, edit at least one of a size, a location, an angle, or a shape of the first object.

4. The electronic device of claim 2, wherein the instructions, when executed by the one or more processors individually or collectively, further cause the electronic device to:
merge the edited first object into a designated region of the image or video.

5. The electronic device of claim 4, wherein the instructions, when executed by the one or more processors individually or collectively, further cause the electronic device to:
when merging the edited first object, adjust at least one of a size, a location, an angle, or a shape of the edited first object.

6. The electronic device of claim 2, wherein the instructions, when executed by the one or more processors individually or collectively, further cause the electronic device to:
based on the edited first object, rearrange the edited first object in the image or video; and
store, in the memory, the rearranged first object together with the metadata of the image or video.

7. The electronic device of claim 1, wherein the instructions, when executed by the one or more processors individually or collectively, further cause the electronic device to:
recognize at least one of a person, a thing, an animal, or a background from the image or video as an object; and
in case that the object is recognized as a single object, divide the recognized object into a plurality of regions of interest to identify the recognized object as a plurality of objects.

8. The electronic device of claim 1, wherein the instructions, when executed by the one or more processors individually or collectively, further cause the electronic device to:
based on the metadata, group the clipping data stored in the memory.

9. The electronic device of claim 8, wherein the instructions, when executed by the one or more processors individually or collectively, further cause the electronic device to:
detect a first predetermined input in a state in which first clipping data is inserted;
in response to the first predetermined input, identify second clipping data in a first group to which the first clipping data belongs; and
change the first clipping data to the second clipping data.

10. The electronic device of claim 8, wherein the instructions, when executed by the one or more processors individually or collectively, further cause the electronic device to:
detect a second predetermined input in a state in which first clipping data is inserted;
in response to the second predetermined input, identify third clipping data in a second group to which the first clipping data belongs; and
change the first clipping data to the third clipping data.

11. A method performed by an electronic device, the method comprising:
recognizing, by the electronic device, a plurality of objects from an image or video displayed on a display of the electronic device;
based on a user input, separating, by the electronic device, one object or multiple objects from the plurality of objects that are recognized;
generating, by the electronic device, clipping data from the one object or multiple objects separated from the plurality of objects;
displaying, by the electronic device, the clipping data on the display; and
storing, by the electronic device in memory of the electronic device, the clipping data together with metadata of the image or video including the plurality of objects.

12. The method of claim 11, further comprising:
after recognizing the plurality of objects, detecting, by the electronic device, a second user input selecting a first object;
based on a third user input, editing, by the electronic device, the first object; and
storing, by the electronic device, the edited first object and the plurality of objects as one object.

13. The method of claim 12, further comprising:
based on the third user input, editing, by the electronic device, at least one of a size, a location, an angle, or a shape of the first object.

14. The method of claim 12, further comprising:
merging, by the electronic device, the edited first object into a designated region of the image or video.

15. The method of claim 14, further comprising:
when merging the edited first object, adjusting, by the electronic device, at least one of a size, a location, an angle, or a shape of the edited first object.

16. The method of claim 12, further comprising:
based on the edited first object, rearranging, by the electronic device, the edited first object in the image or video; and
storing, by the electronic device in the memory, the rearranged first object together with the metadata of the image or video.

17. The method of claim 11, further comprising:
recognizing, by the electronic device, at least one of a person, a thing, an animal, or a background from the image or video as an object; and
in case that the object is recognized as a single object, dividing, by the electronic device, the recognized object into a plurality of regions of interest to identify the recognized object as a plurality of objects.

18. The method of claim 11, further comprising:
based on the metadata, grouping, by the electronic device, the clipping data stored in the memory.

19. One or more non-transitory computer-readable storage media storing one or more computer programs including computer-executable instructions that, when executed by one or more processors of an electronic device individually or collectively, cause the electronic device to perform operations, the operations comprising:
recognizing, by the electronic device, a plurality of objects from an image or video displayed on a display of the electronic device;
based on a user input, separating, by the electronic device, one object or multiple objects from the plurality of objects that are recognized;
generating, by the electronic device, clipping data from the one object or multiple objects separated from the plurality of objects;
displaying, by the electronic device, the clipping data on the display; and
storing, by the electronic device in memory of the electronic device, the clipping data together with metadata of the image or video including the plurality of objects.

20. The one or more non-transitory computer-readable storage media of claim 19, the operations further comprising:
after recognizing the plurality of objects, detecting, by the electronic device, a second user input selecting a first object;
based on a third user input, editing, by the electronic device, the first object; and
storing, by the electronic device, the edited first object and the plurality of objects as one object.
